(19) United States
(12) Patent Application Publication
(10) Pub. No.: US 2019/0135072 A1
(43) Pub. Date: May 9, 2019

(54) Integrated fan bracket and wall assemblies

(71) Applicant: Richard A. Isza, Niles, MI (US)

(72) Inventor: Richard A. Isza, Niles, MI (US)

(21) Appl. No.: 15/732,392

(22) Filed: Nov. 3, 2017

(51) Int. Cl. B60H 1/00; H02K 5/15; H02K 5/22; H02K 7/14; H02K 9/06; H02K 11/30; B60H 1/22; F16M 13/02; F04D 25/06; F04D 25/08; F04D 29/64

(52) U.S. Cl. CPC B60H 1/00464; H02K 5/15; H02K 5/225; H02K 7/14; H02K 9/06; B60N 2/5635; B60H 1/2225; F16M 13/02; F04D 25/06; F04D 25/08; F04D 29/646; H02K 11/30

(57) ABSTRACT

Fan assemblies are provided having an integrated motor bracket, blade shield, and support wall. These elements can be molded from plastic materials with keyed portions of the support wall facilitating installation into application structures, as well as receiving the electrical control circuit for the motor on the support wall. Alteration of bracket web elements in numerically and/or by elevation from the support wall in one or two dimensions allows for immediate visual recognition despite a utilization of a variety of functional of components. Aesthetic appeal to end users can be fostered by the same alterations of the bracket web, as well as other means

### BACKGROUND OF THE INVENTION

The present invention relates to fan assemblies, and, more particularly, to fan assemblies for use in heaters and/or climate control systems for vehicles, such as those mounted under seats in busses and vans.

A wide variety of fan assemblies have been known. In general, a fan assembly includes a motor, a multi-bladed fan attached to a shaft extending from the motor, a bracket which engages the motor and connects it to a supporting structure. Often, the bracket includes a shield or guard for a portion of the fan, and that shield can serve to direct air flow into and/or out of contact with the fan blades. The bracket typically needs Wires typically lead from the motor to a control circuit, the components of which are often mounted onto some additional structure.

The bracket typically needs to provide sufficient structural integrity to maintain motor position and/or shield support without significantly obstructing the flow of air to or from the fan blades. Similarly, the support structure for the assembly typically needs to securely retain the bracket without significantly obstructing the flow of air to or from the fan blades, except that the support structure may be used to define the overall air flow path in the climate control system. Where these fan assemblies are used in vehicles, the components and the connections therebetween need to be able to withstand the additional vibrational stresses imposed by over-the-road usage.

Manufacturing and maintenance requirements can impose fan assembly optimization constraints on fan assemblies. For example, when the fan assemblies are constructed with human manipulation of components, it is important to keep in mind that a certain percentage of the components are likely to be dropped, from time to time. Thus, individual components are preferably designed to be lighter in weight, and/or smaller in size, and/or of rounded shape, so as to minimize, dissipate, and/or deflect destructive stress forces when that component is dropped, and thereby avoid component breakage. However, in order to decrease assembly time and cost, it can be preferable to form fan components into larger and necessarily heavier elements or sections of multiple elements. Further, in order to avoid misalignment of those fan components, it can be preferable to form those components into rectilinear shapes which can be readily aligned with one another. Unfortunately, such larger, rectilinear components tend to be subject to greater destructive stresses on the component, especially when dropped such that the primary impact is on a corner. As a result, the larger, rectilinear components have previously been made of diverse materials and/or of significantly heavier material for reinforcement against such destructive stresses. Doing so, however, can significantly increase the cost of making those components, and, on an accretive basis, even increase the weight of the vehicle in which it is used.

In addition, fan assemblies tend to be subject to the greatest wear and tear in a climate control system, and, thereby, become the first components needed replacement and/or repair. Accordingly, it can be important to design fan assemblies so as to be easily accessed and replaced, especially where less skilled, end user servicing is desired. Unfortunately, optimizing servicing by “modular” construction of fan assemblies can lead to a greater tendency for the modular unit to be damaged in shipping and/or installation, unless more expensive shipping packaging is used. Even then, if the modular unit is inadvertently dropped during servicing, it is more prone to destructive stress damage than would be optimal, unless the structure is significantly reinforced, as discussed above.

Further, many fan assemblies, such as those often used in vehicles, tend to circulate air from the localized environment, which may be dusty, gritty, and/or entrained with oil and/or moisture. Over time, the particulate and entrained matter in the airstream can build up on fan assembly components, covering or deteriorating any labels or component identification indicia. In applications where end user servicing or servicing by non-factory trained persons is expected, this can lead to difficulties in obtaining the correct replacement parts. Ideally, and especially where internet communications are readily available, the end user would not need to send the broken or worn out component back to the dealer or manufacturer in order to obtain a replacement component. Instead, the end user would indicate the part number of the component or send a photograph of the component for that identification purpose. In vehicular applications, the part number can be obscured, as described, or the part number label may have separated from the part, but the component configuration can usually still be photographed. However, in order to avoid confusion with other fan assemblies using similar but not identical components, each such component would, preferably, be created with a sufficiently distinct and readily ascertainable configuration.

Moreover, where end user servicing is anticipated, it can be important to maintain customer confidence in the value of the fan assembly product. The product has, by definition, failed in some respect at the time of the end user servicing, and end user can be expected to have the disfunctional component literally “in hand” for replacement. At that time, if the component has been formed with an aesthetically attractive configuration, from the standpoint of perceived robustness and/or durability, for example, even the incidental failure of the component can be discounted by the end user, as, for example, an unusual or one-time event. This would be in contrast, for example, to the end user disassembling the fan product and immediately discounting the failed component as a “flimsy piece of junk” in the first place merely because of its aesthetic appearance.

### OBJECTIVES OF THE INVENTION

Accordingly, an objective of the present invention is to provide improved fan assemblies, particularly for use in vehicles. These improvements include providing fan assemblies which:
a. are inexpensive to make and reliable in operation,
b. are less prone to breakage during manufacture or servicing,
c. increase the spacial optimization of structures into which the fan assemblies are applied,
d. are readily distinguishable in appearance from related products, and
e. increase the aesthetic appeal of the fan assembly as well as the application structures into which the fan assemblies are applied.

### SUMMARY OF THE INVENTION

These and other objectives of the present invention are achieved by the provision of fan assemblies having an integrated motor bracket, blade shield, and support wall. These elements can be molded from plastic materials with keyed portions of the support wall facilitating installation into application structures, as well as receiving the electrical control circuit for the motor on the support wall. Alteration of bracket web elements in numerically and/or by elevation from the support wall in one or two dimensions allows for immediate visual recognition despite a utilization of a variety of functional of components. Aesthetic appeal to end users can be fostered by the same alterations of the bracket web, as well as other means.

Other objects, advantages, and novel features of the present invention will become readily apparent from the following drawings and detailed description of certain preferred and alternative embodiments.

### BRIEF DESCRIPTION OF THE DRAWINGS

FIG. 1 shows a top view of a separable portion of a prior fan assembly, deemed prior art.

FIG. 2 shows a top perspective view of the device of FIG. 1.

FIG. 3 shows a top view of the integrated fan assembly of the present invention.

FIG. 4 shows a bottom view of the assembly of FIG. 3

FIG. 5 shows an end view of the assembly of FIG. 3, from the lower end shown in FIG. 3.

FIG. 6 shows a top perspective view of the assembly of FIG. 3 from the lower right end shown in FIG. 3.

FIG. 7 shows a schematic top view of the integrated fan assembly of the present invention.

FIG. 8 shows a side schematic view of the assembly of FIG. 7, from the lower end shown in FIG. 7.

FIG. 9 shows a side schematic view of the assembly of FIG. 7, partially exploded, as mounted into a generic heater for a motor vehicle.

### DETAILED DESCRIPTION OF PREFERRED EMBODIMENTS

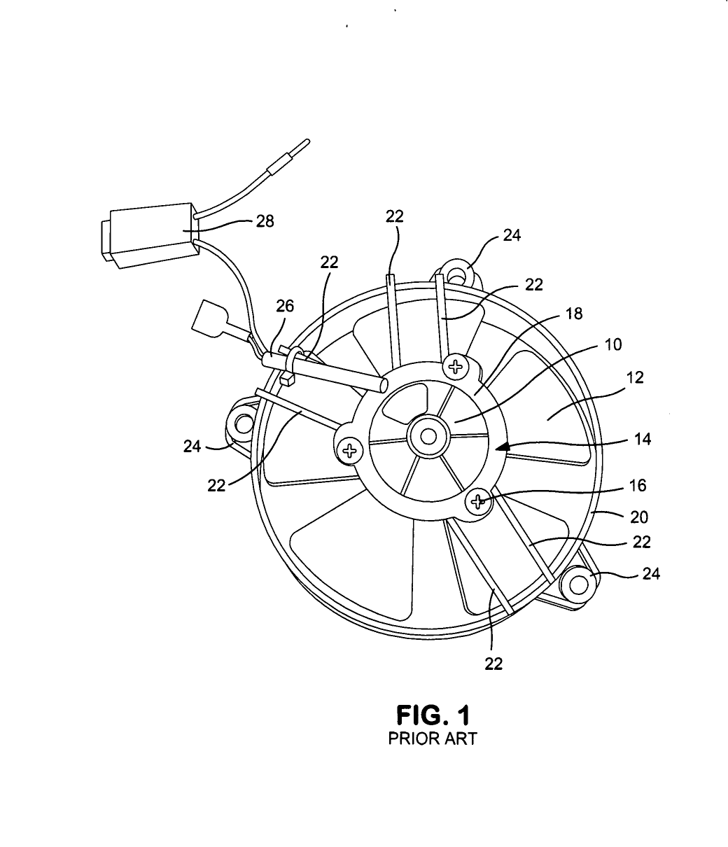

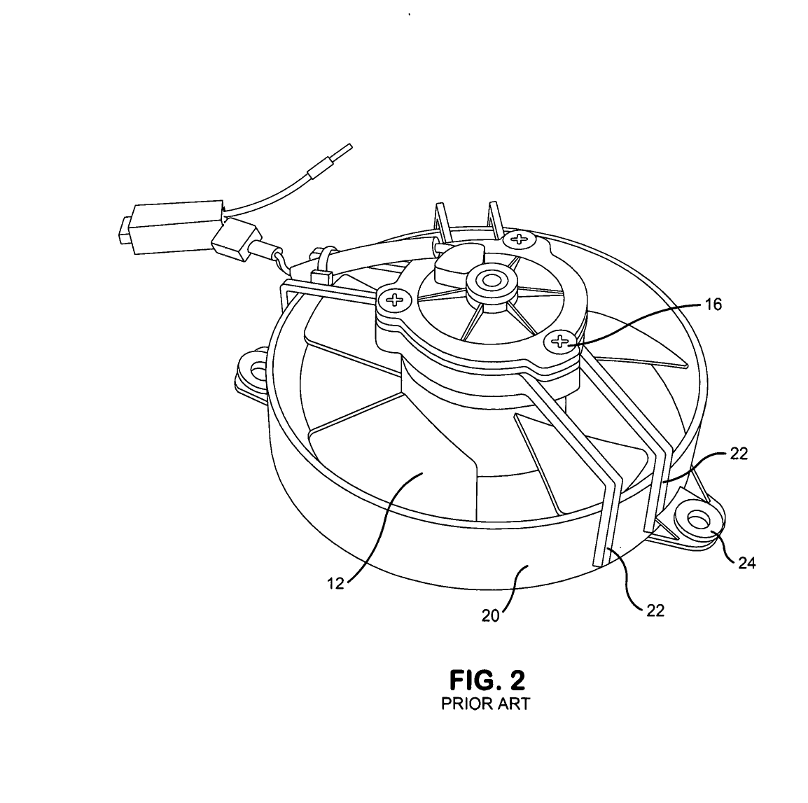

FIGS. 1 and 2 are included to highlight the distinctions between the present invention and the prior art. These figures show a separable portion of a fan assembly having a motor 10, connected to a multi-bladed fan 12. Motor 10 is secured to a bracket 14 by screw fasteners 16 into mounting ring 18. Bracket 14 includes a peripheral shield 20 joined to ring 18 by a bracket web having three opposing pairs of struts 22. Shield 20 includes three mounting flanges 24 for separably securing this portion of the fan assembly to a conventional support wall or structure. Wires 26 are connected between motor 10 and a control circuit and related electrical elements 28.

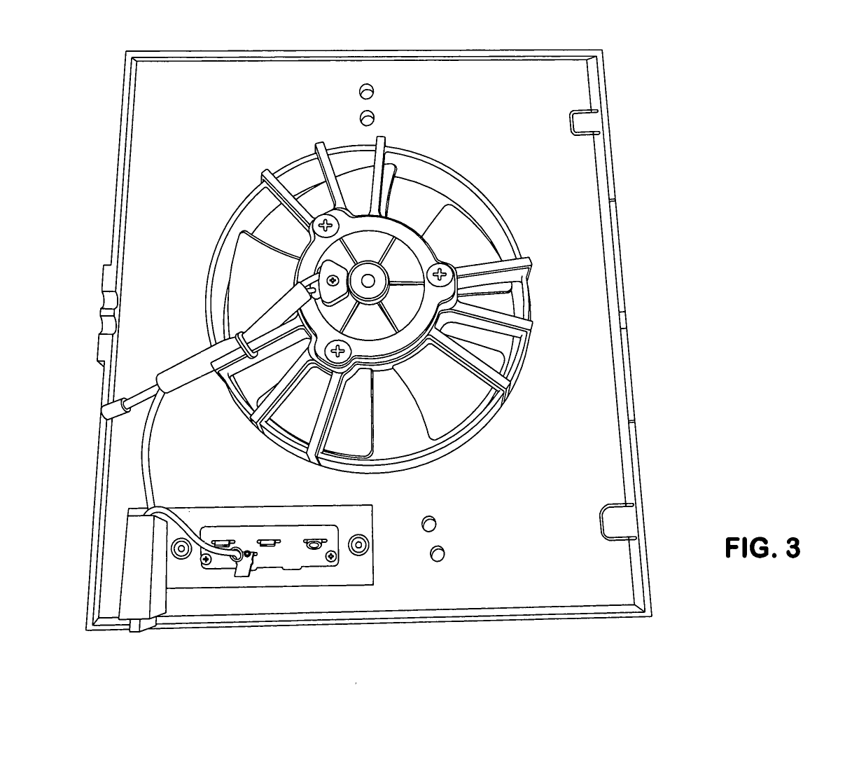

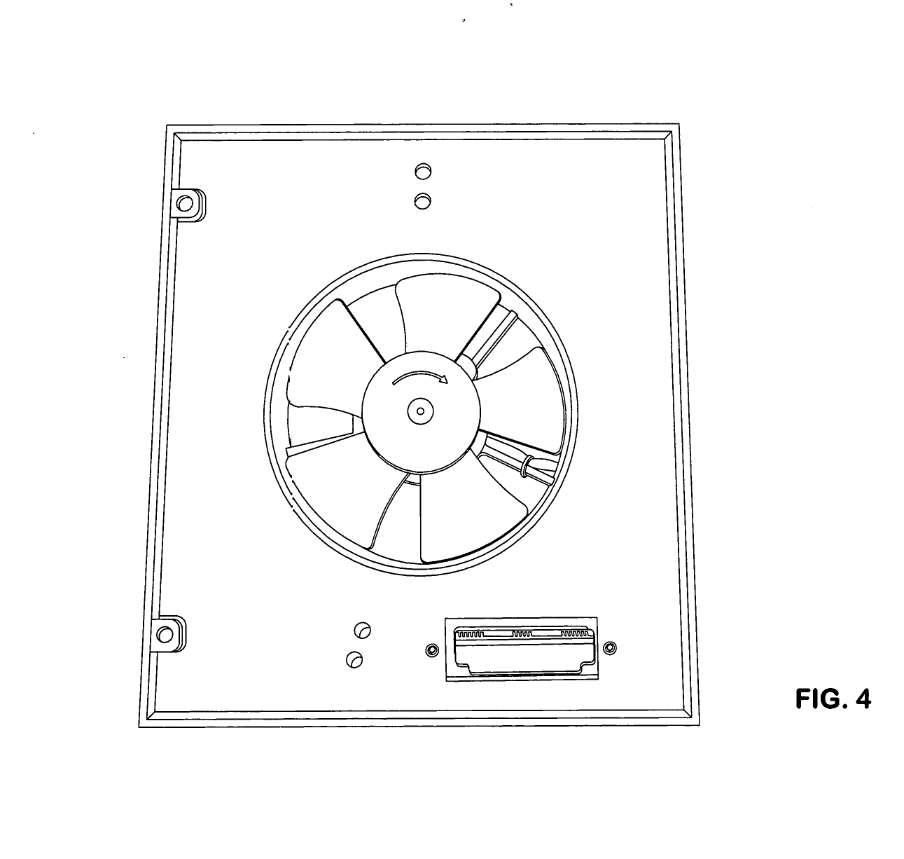

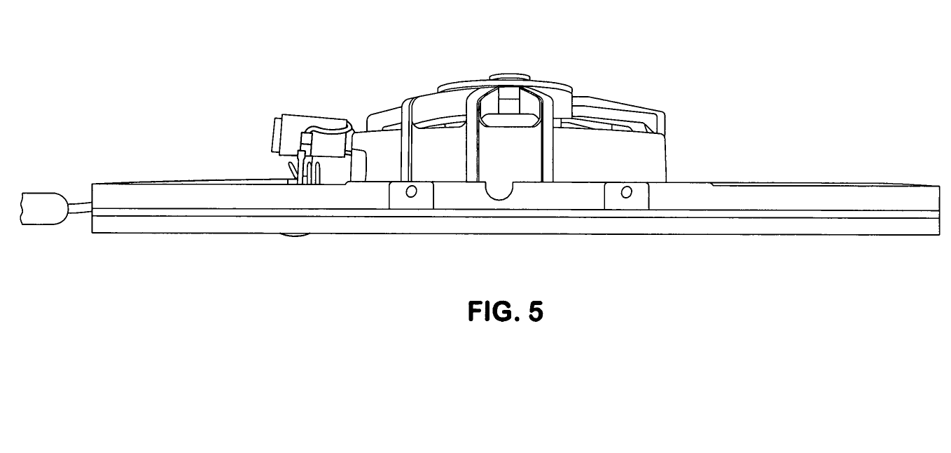

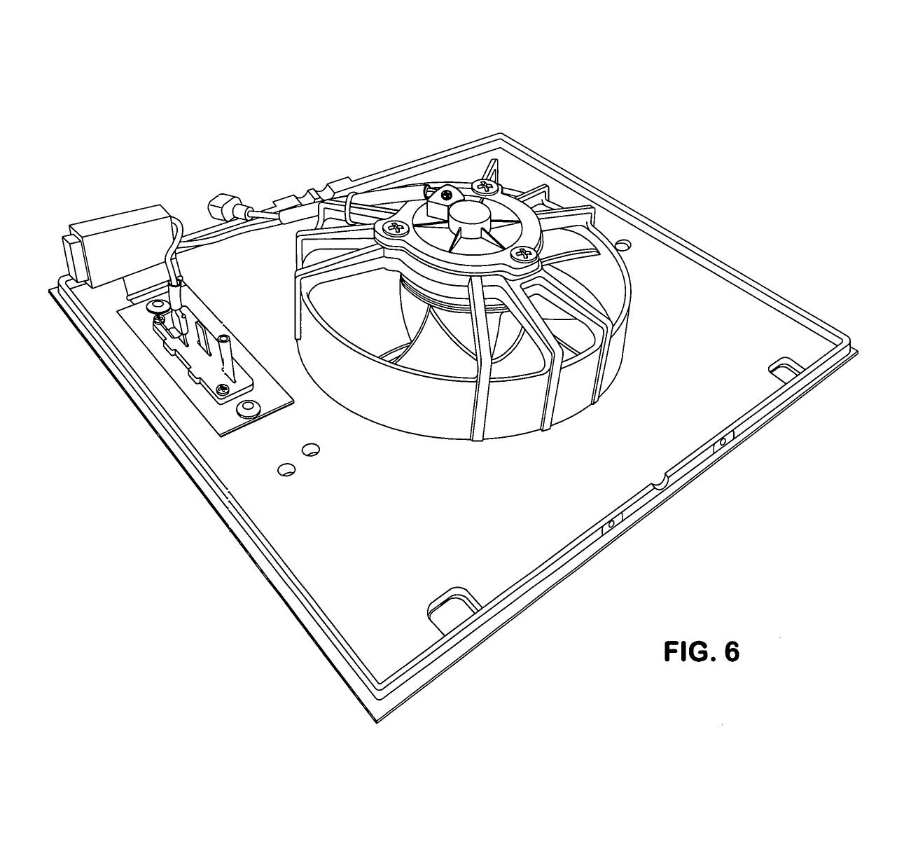

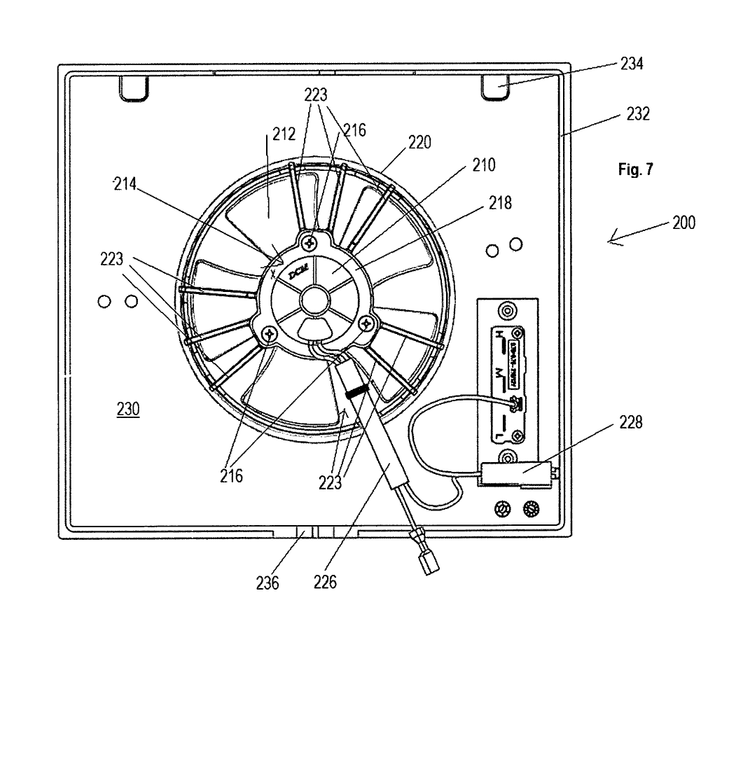

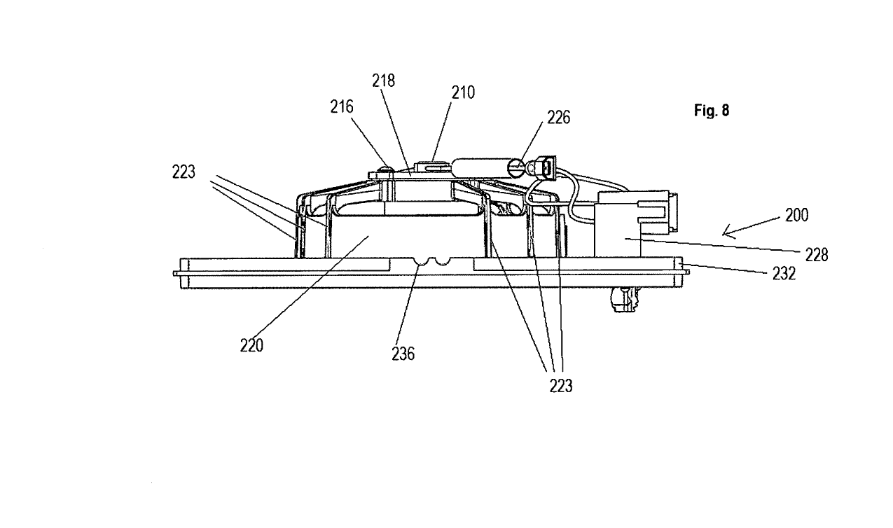

In FIGS. 3-8, the drawings show preferred embodiments of the present invention as applied to fan assemblies for use in connection with otherwise conventional heaters for use in motor vehicles. The present invention also is applicable to a wide variety of heaters and other environmental control systems, both for vehicular use and otherwise.

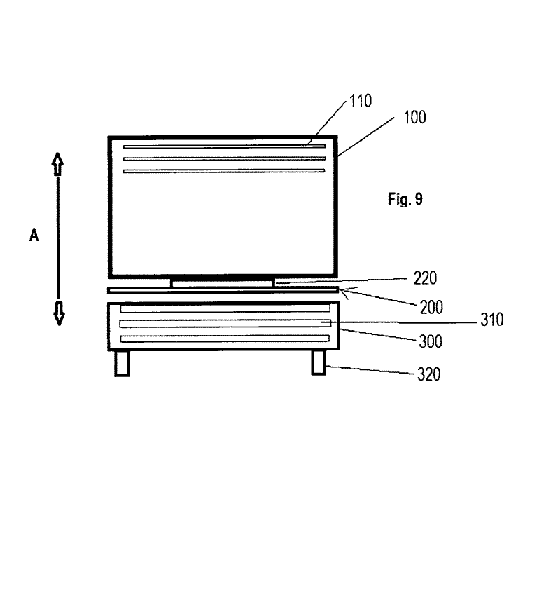

FIG. 9 shows a preferred embodiment of the present as applied for mounting into a generic heater for a motor vehicle. The heater is exploded into primary sections along vertical line A, such as top heat producing section 100, having intake air vents 110, intermediate fan assembly 200, showing shield 220, and lower hot air manifold section 300, having outlet air vents 310 and floor feet 320 for engaging the interior floor of the vehicle. The specific orientation of the air vents and the components used in the top and lower sections are conventional in nature. Intermediate fan assembly 200 is the subject of the present invention.

FIGS. 3-8 illustrate the aesthetic and ornamental design of the present invention, as applied to a specific fan assembly. The background structure, product labels and brands, and support indicia in the figures form no portion of the claimed design. Also, the specific wiring and electrical components used in the fan assembly form no portion of the claimed design. Color forms no portion of the claimed design

The following features of the fan assembly 200 of the present invention are illustrated in the drawings:
a motor 210, preferably of conventional construction and design,
a multi-bladed fan 212 rotatably connected to motor 210, preferably of conventional construction and design,
a bracket 214 for removably retaining the motor and fan in a fixed relationship to the desired air flow path,
bracket 214 including a mounting ring 218 for receiving motor 210, and conventional fasteners 216, such as screws, to removably secure motor 210 to ring 218,
bracket 214 also including a shield 220 extending about the periphery of fan 212, and a bracket web connecting shield 220 to ring 218,
that bracket web comprising a plurality of strut sections disposed about the circumference of ring 218 and shield 220, three such strut sections being illustrated in the preferred embodiments of FIGS. 3-8,
each strut section of the preferred embodiments having three strut spaced apart elements 223,
strut elements 223 extending vertically above shield 220 to the level of ring 218, and project radially outward over the outer peripheral surface of shield 200 (the inner peripheral surface being adjacent the fan) so as to be visually distinct with respect to the fan assembly,
support wall or surface 230, which is integrated into shield 220, such as by molding those two elements as a single unit or by welding or otherwise bonding the two elements so as to be inseparable in the ordinary course of usage,
support surface 230 including a keyed peripheral formation 232 about its circumference for facilitating installation and/or assembly into a particular application, such as connection with sections 100 and 300 of FIG. 9, that formation preferably being of conventional construction and design,
support surface 230 also including conventional mounting tabs 234 to facilitate releasable attachment of support surface 230 to a particular application, and
support surface 230 further including wire pathways 236 therefrom, to accommodate whatever entering or exiting wires 226 are needed for operation of motor 210, and space within support surface 230 for mounting and/or retaining related electrical elements 228 associated with motor 210.

In especially preferred embodiments, bracket 214 (including ring 218, struts 223, and shield 220) and support surface 230 are integrally molded from a thermoplastic material. In applications where support surface 220 is needed for definition of the air flow through the heater, support surface 220 can be a solid wall from its periphery inward to shield 220. In other embodiments, support surface 220 can itself be a web structure or have significant openings therethrough between keyed formation 232 and shield 220, so as to save on overall weight and/or material used in fan assembly 200.

A distinguishing feature of the present invention provides for the use of a unique aesthetic appearance for each embodiment of the fan assembly, minimizing the risk of incorrect components being installed when servicing the fan assembly or heater. For example, when the heater is disassembled for servicing, the bracket web is readily observed and recognizable. The robust nature of its appearance contributes to its aesthetic appeal and reinforces the perception of reliability of the fan assembly. At the same time, however, the bracket web serves as a readily photographable indicia of the specific fan assembly embodiment which can be forwarded by end users to order replacement parts. Other embodiments of fan assemblies using the teaching of the present invention can employ differentiated bracket webs. For example, instead of three strut sections using three strut elements each, another embodiment could employ three strut sections using fourth strut elements each, or three strut sections using four strut elements in one section and two strut elements in each of the other two strut sections.

Further, continuing the visual indicia of the strut elements down onto the outer periphery of shield 220 facilitates photographing and/or visual recognition of the specific bracket web appearance. Bracket web differentiation among fan assembly embodiments could utilize alteration of that continuity, as needed.

Although the present invention has been shown and described herein with respect to certain preferred embodiments and alternative configurations, those were by way of illustration and example only. The scope of the present invention is intended to be limited only by the terms of the appended claims.

What is claimed is:

1. The ornamental design for integrated fan bracket and wall assemblies, substantially as shown and described in FIGS. 3-6.

2. A fan assembly for use within a heater application of a vehicle, comprising:
a motor,
a fan connected to the motor,
a bracket for receiving the motor,
the bracket having a mounting element connectable to the motor, a shield positioned about the periphery of the fan, and a web joining the mounting element and the shield,
a support surface for connecting the bracket to other portions of the heater application,
the support surface and the bracket being integrally formed and inseparably contained.

3. The fan assembly according to claim 2 wherein the web comprises a plurality of sections disposed about a periphery of the shield and the mounting element.

4. The fan assembly according to claim 3 wherein each section comprises a plurality of struts extending vertically and radially with respect to the outer periphery of the shield.
